(19) United States
(12) Patent Application Publication
(10) Pub. No.: US 2010/0179008 A1
(43) Pub. Date: Jul. 15, 2010

(54) LINK PLATE FOR A SILENT CHAIN

(75) Inventor: Kouji Morishige, Nabari-shi (JP)

Correspondence Address: BORGWARNER INC.;c/o Brown & Michaels, PC, 400 M&T Bank Building, 118 N. Tioga Street, Ithaca, NY, 14850, US

(73) Assignee: BORGWARNER MORSE TEC JAPAN K.K., Nabari-shi, Mie (JP)

(21) Appl. No.: 12/095,569

(22) PCT Filed: Dec. 14, 2006
(86) PCT No.: PCT/JP2006/325665

§ 371 Date: May 30, 2008

(30) Foreign Application Priority Data
Dec. 14, 2005 (JP) 2005-359794

(51) Int. Cl. F16G 13/04; F16G 15/12

(52) U.S. Cl. 474/213

(57) ABSTRACT

The present invention provides a link plate for a silent chain that can introduce and maintain adequate lubricant in the pin aperture without decreasing the strength of the link plate. A silent chain (1) is comprised of a plurality of link plates (2) each having a pair of teeth (22) and pin apertures (21). The link plates (2) are interlaced in the lateral and longitudinal direction and pivotably interconnected to each other via connecting pins (3) inserted into the apertures (21). At least one groove (25) is formed at only the tooth (22) region on at least either one of an outer surface or an inner surface of the link plate (2). The groove (25) extends from the tip (22A) of the tooth (22) to the pin aperture (21). A width of the groove (25) becomes gradually wide toward the tip (22A) of the tooth (22) from the pin aperture (21).

### TECHNICAL FIELD

The present invention relates to a link plate for a silent chain, and more particularly, to an improvement of the structure in order to introduce and maintain adequate lubricant in the pin aperture without decreasing the strength of the link plate.

### BACKGROUND ART

Silent chains are used as timing chains for automobiles, motorcycles and the like. A silent chain is generally formed of a plurality of link plates each having a pair of teeth and pin apertures and pivotably connected to each other via connecting pins inserted into the pin apertures.

In operation of the silent chain, adequate lubricant should be supplied into the pin apertures in order to decrease wear to the connecting pins and pin apertures. However, since the silent chain has a structure in which a plurality of link plates are interlaced closely in layers along the length of the connecting pins, adequate lubricant is hardly supplied into the pin apertures.

In prior art, Japanese utility model registration application laying-open publication No. 56-102850 (JP 56-102850) describes an oil groove formed on the link plate and extending from the distal end portion of the tooth of the link plate to the back side portion through the pin aperture (see FIG. 5). Also, Japanese utility model registration application laying-open publication No. 59-54248 (JP 59-54248) describes an oil groove formed on the tooth of the link plate and extending from the inside flank surface, outside flank surface, or back side surface to the pin aperture (see FIGS. 2 and 3).

However, in JP 56-102850, since the oil groove is formed extending from the pin aperture to the back side portion, during operation of the silent chain, lubricant in the pin apertures flows through the oil groove via centrifugal force and may be discharged to the back side surface of the link plate. In this case, it is difficult to hold lubricant in the pin aperture.

In JP 59-54248, the oil groove is formed extending from the inside flank surface and (or) the outside flank surface to the pin aperture. These portions having the oil groove formed receive a compressive load at the time of engagement of the link plate with the sprocket, and are the thinnest portion between the pin aperture and the inner and outer flank surface, and they are the weakest portion of the link plate. Therefore, when the oil groove is formed on the inner and outer flank surface, the link plate becomes short of strength and a crack may occur on the link plate during operation.

Also, in JP 59-54248, when the oil groove is formed on the link plate extending from the pin aperture to the back side surface, similar to JP 56-102850, lubricant in the pin apertures flows through the oil groove via centrifugal force and may be discharged to the back side surface of the link plate, and it is difficult to hold lubricant in the pin aperture.

The present invention has been made in view of these conventional circumstances, and its object is to provide a link plate for a silent chain that can introduce and maintain adequate lubricant in the pin aperture without decreasing the strength of the link plate.

### DISCLOSURE OF INVENTION

A link plate for a silent chain according to a first aspect of the present invention has at least one groove formed at only the tooth region on at least either one of an outer surface or an inner surface of the link plate. The groove extends from the tip of the tooth to the pin aperture and opens into the tip of the tooth and an inner circumferential surface of the pin aperture.

According to the first aspect of the present invention, lubricant enters the opening end of the groove at the tip of the tooth, flows through the groove in the tooth, and is introduced into the pin aperture from the opening end of the groove at the pin aperture. In this case, since the groove is formed at only the tooth region, lubricant in the pin aperture will not be discharged to the back side of the link plate via the centrifugal force during operation of the silent chain. Thereby, lubricant introduced into the pin aperture can be maintained. Also, in this case, since the groove is open to the tip of the tooth portion and is not open to the inner and outer flank surface, a lack of strength of the link plate will not occur.

In another aspect of the present invention, a width of the groove at an opening end of the tip of the tooth is wider than a width of the groove at an opening end of the pin aperture.

In this case, since the width of the groove at the opening end of the tip of the tooth is wide, entry of lubricant into the groove from the tip of the tooth becomes easy and lubricant can thus be securely introduced into the groove.

In a still another aspect of the present invention, the width of the groove becomes gradually wide toward the tip of the tooth from the pin aperture.

### BRIEF DESCRIPTION OF DRAWINGS

FIG. 1 is a perspective view of a link plate according to an embodiment of the present invention;

FIG. 2 is a bottom view of a portion of a silent chain formed of link plates shown in FIG. 1;

FIG. 3 is a perspective view of a link plate according to a second embodiment of the present invention; and

FIG. 4 is a bottom view of a portion of a silent chain formed of link plates shown in FIG. 3.

### BEST MODE FOR CARRYING OUT THE INVENTION

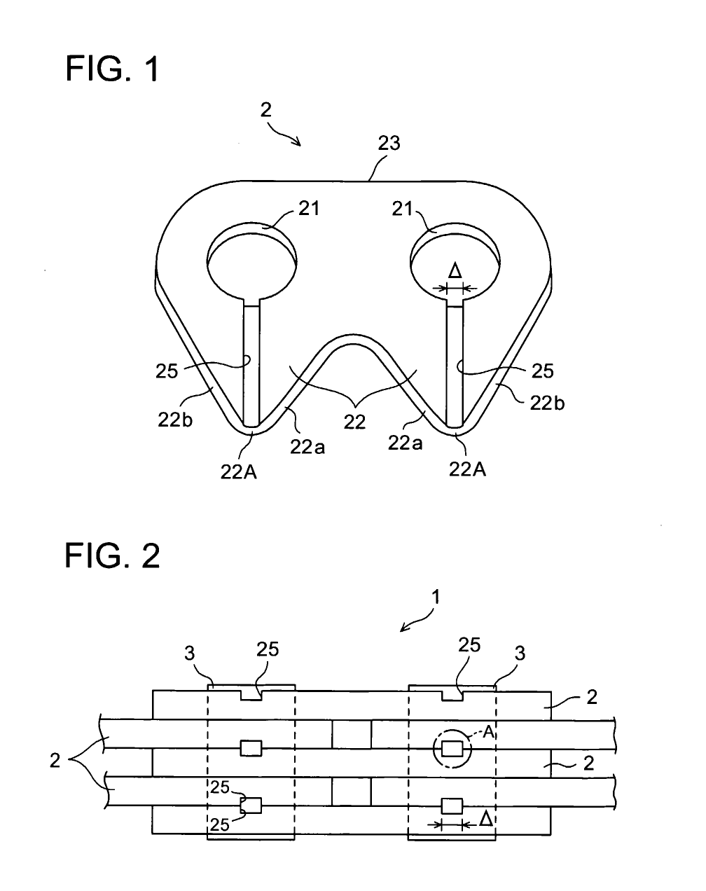

FIGS. 1 and 2 illustrate a link plate for a silent chain according to a first embodiment of the present invention. As shown in FIG. 1, a link plate 2 has a pair of pin apertures 21 and teeth 22 depending downwardly from the pin apertures 21 in a triangular shape. Each of the teeth 22 is formed of an inside flank surface 22a and an outside flank surface 22b.

On the outer surface (i.e. front surface) or the inner surface (i.e. rear surface) of each of the teeth 22 of the link plate 2, a groove 25 is formed extending from the tip 22A of the tooth 22 to the pin aperture 21. The groove 25 is open to both the inner circumferential surface of the pin aperture 21 and the tip 22A of the tooth 22. Also, a width of the groove 25 is Δ at both the opening end of the inner circumferential surface of the pin aperture 21 and the opening end of the tip 22A of the tooth 22. The oppositely disposed sidewall surfaces of the groove 25 extend in parallel from the pin aperture 21 to the tip 22A of the tooth 22.

FIG. 2 shows a silent chain formed of link plates 2 shown in FIG. 1. The silent chain 1 is comprised of a plurality of link plates 2 of FIG. 1 interlaced in the lateral direction (i.e. the width direction) and the longitudinal direction (i.e. the length direction) and pivotably connected to each other via connecting pins 3 inserted into the pin apertures 21. The silent chain in FIG. 2 is viewed from the bottom side or the side of the tip 22A of the teeth 22.

As shown in FIG. 2, in some of a plurality of pairs of link plates 2 that are adjacent to each other in the lateral direction, corresponding grooves 25 are disposed oppositely to each other (see a portion A). Thereby, a depth of the groove twice as deep as a single groove 25 can be secured. That allows for an easy entry of lubricant from the opening end of the groove 25 at the tip 22A of the tooth 22.

During operation of the silent chain 1, lubricant enters the groove 25 from the opening end thereof at the tip 22A of the tooth 22, flows through the groove 25 in the tooth 22, and is introduced into the pin aperture 21 from the opening end thereof.

In this case, since the groove 25 is formed at only the tooth 22 region, lubricant in the pin aperture 21 will not be discharged to the back surface 23 side of the link plate 2 via the centrifugal force during operation of the silent chain 1. Thereby, lubricant introduced into the pin aperture 21 can be maintained. Also, in this case, since the groove 25 is open to the tip 22A of the tooth 22 and is not open to the inner flank surface 22a and the outer flank surface 22b, a lack of strength of the link plate 2 will not occur.

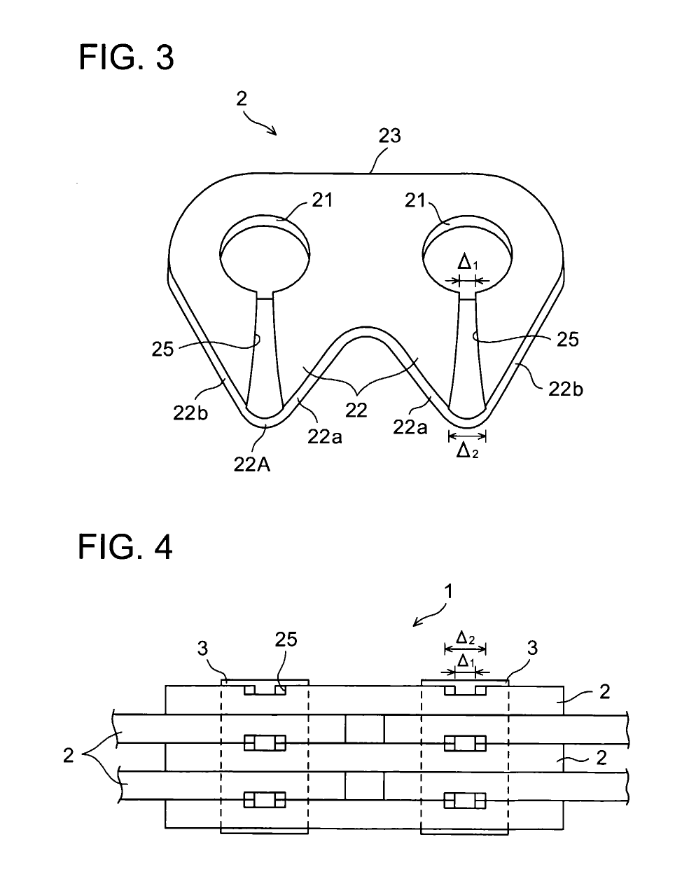

FIGS. 3 and 4 illustrate a link plate for a silent chain according to a second embodiment of the present invention. In these drawings, like reference numbers indicate identical or functionally similar elements.

The second embodiment differs from the first embodiment in that a width Δ₂ of the groove 25 at an opening end of the tip 22a of the tooth 22 is wider than a width Δ₁ of the groove 25 at an opening end of the pin aperture 21. Also, in the example shown in FIG. 3, the width of the groove 25 becomes gradually wide toward the tip 22a of the tooth 22 from the pin aperture 21. The groove 25 is formed in a tapered shape.

In this case, since the width Δ₂ of the groove 25 at the opening end of the tip 22a of the tooth 22 is wide, entry of lubricant into the groove 25 from the tip 22a of the tooth 22 becomes easy and lubricant can thus be securely introduced into the groove 25.

In the above-mentioned embodiments, examples were shown in which the groove 25 is formed on either one of the outer surface or the inner surface of the link plate 2, but the groove 25 may be formed on both the outer surface and the inner surface of the link plate 2. Also, the number of grooves 25 may be two or more.

### INDUSTRIAL APPLICABILITY

A link plate for a silent chain according to the present invention is useful for any type of link plates in use for a silent chain. The present invention also has application to a link plate having a single tooth.

1. A link plate for a silent chain in which a plurality of link plates each having a tooth and a pin aperture are interlaced in the lateral and longitudinal direction and pivotably interconnected to each other via connecting pins inserted into the apertures,
wherein at least one groove is formed at only the tooth region on at least either one of an outer surface or an inner surface of the link plate, the groove extending from the tip of the tooth to the pin aperture and opening into the tip of the tooth and an inner circumferential surface of the pin aperture.

2. The link plate according to claim 1, wherein a width of the groove at an opening end of the tip of the tooth is wider than a width of the groove at an opening end of the pin aperture.

3. The link plate according to claim 2, wherein the width of the groove becomes gradually wide toward the tip of the tooth from the pin aperture.
